(19) United States
(12) Patent Application Publication
(10) Pub. No.: US 2022/0236705 A1
(43) Pub. Date: Jul. 28, 2022

(54) MANAGEMENT APPARATUS, MANAGEMENT METHOD, AND PROGRAM

(71) Applicant: HITACHI-JOHNSON CONTROLS AIR CONDITIONING, INC., Tokyo (JP)

(72) Inventor: Yoshihiro MACHIDA, Tokyo (JP)

(21) Appl. No.: 17/613,657

(22) PCT Filed: May 23, 2019
(86) PCT No.: PCT/JP2019/020512

§ 371 Date: Nov. 23, 2021

(51) Int. Cl. G05B 19/042; H04L 67/12

(52) U.S. Cl. CPC G05B 19/042; G05B 2219/2614; H04L 67/12

(57) ABSTRACT

Provided is, e.g., a management apparatus configured to manage multiple types of instruments at low cost. A management apparatus includes a first communication unit connected to an air-conditioner via a first instrument network (ka), a second communication unit connected to instruments including a monitoring camera, a door lock mechanism, and an illuminating apparatus via a second instrument network, a third communication unit connectable to an upper apparatus, and a control unit configured to control the air-conditioner or the instruments based on a combination of the state of the air-conditioner received via the first communication unit and the states of the instruments received via the second communication unit.

### TECHNICAL FIELD

The present invention relates to, e.g., a management apparatus.

### BACKGROUND ART

A building management system (BMS) configured to manage multiple types of instruments, which include an air-conditioner, a monitoring camera, and an illuminating apparatus in a building, in whole has been known. Regarding such a building management system, Patent Literature 1 describes, for example, a building management system including a LonWorks system coupling a facility other than a multi air-conditioner system to a BMS controller and a multi air-conditioner system remote controller coupled to the LonWorks system.

### CITATION LIST

### Patent Literature

PATENT LITERATURE 1: JP-A-2008-176767

### SUMMARY OF INVENTION

### Problems to be Solved by Invention

In the technique of Patent Literature 1, in a case where there is a predetermined state change (human detection or ON/OFF of an illuminating apparatus) in a human detection sensor or the illuminating apparatus, such a state change is notified to the multi air-conditioner system remote controller, and is reflected on air-conditioning control. On the other hand, a setting device other than the multi air-conditioner system, such as the human detection sensor and the illuminating apparatus, is controlled based on a command from the BMS controller. Thus, in a building provided with no BMS controller, when the power of the multi air-conditioner system is, for example, turned off by the remote controller, it is difficult to perform the control of automatically turning off the illuminating apparatus accordingly.

Further, in the technique of Patent Literature 1, the BMS controller needs to be provided even at a small-sized facility, and for this reason, an installation cost is high. In the small-sized facility, there is room for further cost reduction by overall control of the multiple types of instruments by a simple configuration.

Thus, the present invention is intended to provide, e.g., a management apparatus configured to manage multiple types of instruments at low cost.

### Solution to Problems

For solving the above-described problems, the present invention includes a first communication unit connected to an air-conditioner via a first instrument network, a second communication unit connected to one or more types of instruments different from the air-conditioner via a second instrument network, a third communication unit connectable to an upper apparatus, and a control unit configured to control the air-conditioner or the instruments based on a combination of the state of the air-conditioner received via the first communication unit and the states of the instruments received via the second communication unit.

### Effects of Invention

According to the present invention, e.g., the management apparatus configured to manage the multiple types of instruments at low cost can be provided.

### BRIEF DESCRIPTION OF DRAWINGS

FIG. 1 is a configuration diagram of a management system including a management apparatus according to a first embodiment of the present invention.

FIG. 2A is a diagram for describing a hardware configuration of the management apparatus according to the first embodiment of the present invention.

FIG. 2B is a diagram for describing a functional configuration of the management apparatus according to the first embodiment of the present invention.

FIG. 3 is a sequence diagram of processing in the management system including the management apparatus according to the first embodiment of the present invention.

FIG. 4 is a diagram for describing an example of an object list regarding an air-conditioner in the management system including the management apparatus according to the first embodiment of the present invention.

FIG. 5 is a diagram for describing an example of an instrument management database included in the management apparatus according to the first embodiment of the present invention.

FIG. 6 is a diagram for describing an example of a cooperation rule set in the management apparatus according to the first embodiment of the present invention.

FIG. 7 is an example of a packet format of information notified as the object list to the management apparatus according to the first embodiment of the present invention.

FIG. 8 is a flowchart showing the processing of the air-conditioner in the management system including the management apparatus according to the first embodiment of the present invention.

FIG. 9 is a flowchart showing the processing of a control unit of the management apparatus according to the first embodiment of the present invention.

FIG. 10 is a configuration diagram of a management system including a management apparatus according to a second embodiment of the present invention.

FIG. 11 is a diagram for describing switching of a management subject in the management system including the management apparatus according to the second embodiment of the present invention.

FIG. 12 is a time chart regarding an upper apparatus, the management apparatus, and an instrument in the management system including the management apparatus according to the second embodiment of the present invention.

FIG. 13 is a flowchart showing the contents of the processing of a control unit of the management apparatus according to the second embodiment of the present invention.

FIG. 14 is a sequence diagram of processing in a management system including a management apparatus according to a variation of the present invention.

### DESCRIPTION OF EMBODIMENTS

### First Embodiment

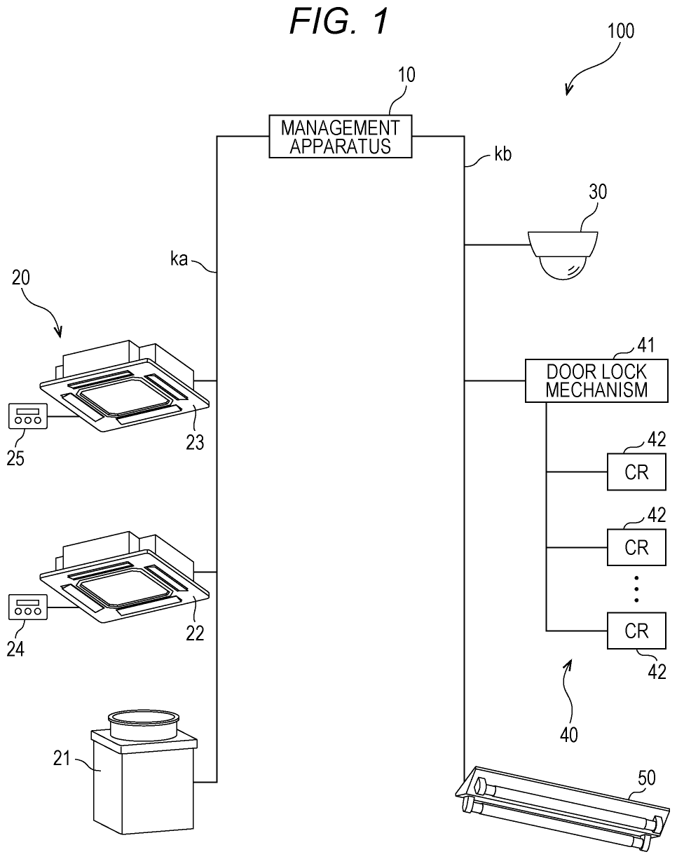

FIG. 1 is a configuration diagram of a management system 100 including a management apparatus 10 according to a first embodiment.

The management system 100 is a system configured to manage multiple types of instruments such as an air-conditioner 20 and a monitoring camera 30. As shown in FIG. 1, the management system 100 includes, in addition to the management apparatus 10, a first instrument network ka and a second instrument network kb connected to the management apparatus 10. In addition to the air-conditioner 20 and the monitoring camera 30, a door lock mechanism 41 and an illuminating apparatus 50 are provided as the multiple types of instruments targeted for management by the management apparatus 10.

The air-conditioner 20 is an instrument configured to perform air conditioning such as air-cooling operation or air-heating operation. In an example of FIG. 1, the air-conditioner 20 includes a top-blowing type outdoor unit 21, two ceiling-embedded type indoor units 22, 23, and remote controllers 24, 25. Note that the outdoor unit 21 and the indoor units 22, 23 are connected to each other through a refrigerant pipe (not shown). Refrigerant circulates in a well-known refrigeration cycle to perform predetermined air-conditioning operation.

The outdoor unit 21 and the indoor units 22, 23 are connected to the management apparatus 10 via the first instrument network ka. The first instrument network ka is a local network for performing communication according to a unique protocol or a predetermined protocol suitable for, e.g., LonWorks (the registered trademark). Predetermined local communication addresses are assigned to the outdoor unit 21 and the indoor units 22, 23 connected to the first instrument network ka, and predetermined communication is performed among the outdoor unit 21 and the indoor units 22, 23. Based on user's operation via the remote controllers 24, 25, the air-conditioner 20 performs the predetermined air-conditioning operation.

The monitoring camera 30, the door lock mechanism 41, and the illuminating apparatus 50 are different types of “instruments” from the air-conditioner 20, and are connected to the management apparatus 10 via the second instrument network kb.

The monitoring camera 30 is a camera configured to monitor the inside of a room, and is placed to monitor air-conditioning target spaces of the indoor units 22, 23. The monitoring camera 30 has a human detection function, and transmits not only the presence or absence of a person in the room but also the number of persons in the room if there are any persons in the room to the management apparatus 10 via the second instrument network kb.

The door lock mechanism 41 is a mechanism configured to lock/unlock doors (not shown) based on, e.g., signals from card readers 42 (shown as “CR” in FIG. 1). Note that the door lock mechanism 41 is placed at a door of each room air-conditioned by the indoor units 22, 23.

The multiple card readers 42 are apparatuses configured to contactlessly read information in card keys (not shown) owned by users. Note that a configuration including the door lock mechanism 41 and the card readers 42 will be referred to as an entry/exit system 40.

The illuminating apparatus 50 is an apparatus configured to irradiate the inside of the room with light. ON/OFF of the illuminating apparatus 50 is switched by operation of a switch (not shown) provided at a predetermined room or a control command from the management apparatus 10. Note that the room irradiated with light from the illuminating apparatus 50 is also an air-conditioning target space of the air-conditioner 20.

FIG. 1 shows the example where the monitoring camera 30, the door lock mechanism 41, and the illuminating apparatus 50 are connected to the common (single) second instrument network kb, but the present invention is not limited to such an example. That is, the monitoring camera 30, the door lock mechanism 41, and the illuminating apparatus 50 may be connected to separate second instrument networks kb. Alternatively, the monitoring camera 30, the door lock mechanism 41, and the illuminating apparatus 50 may be different communication protocols.

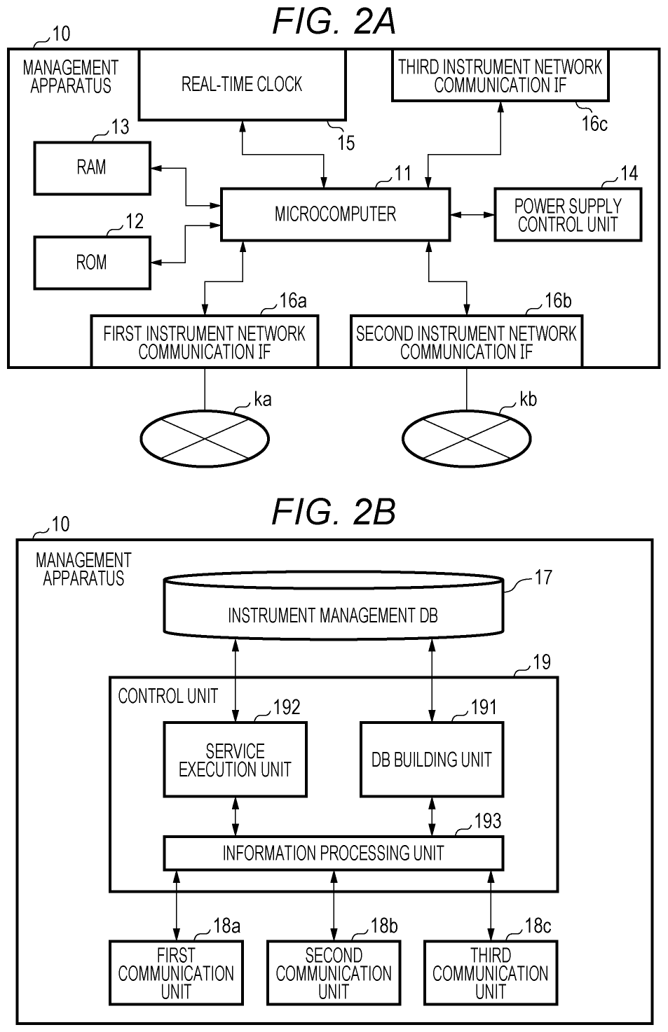

The management apparatus 10 is an apparatus configured to manage cooperation control for instruments such as the door lock mechanism 41 and the illuminating apparatus 50 in addition to the air-conditioner 20 and the monitoring camera 30. Note that the “cooperation control” means that based on the states of one or more instruments (e.g., the air-conditioner 20), other instruments (e.g., the illuminating apparatus 50) are controlled. The hardware configuration and functional configuration of the management apparatus 10 will be sequentially described with reference to FIGS. 2A and 2B.

FIG. 2A is a diagram for describing the hardware configuration of the management apparatus 10.

As shown in FIG. 2A, the management apparatus 10 includes, as the hardware configuration, a microcomputer 11, a read only memory (ROM) 12, a random access memory (RAM) 13, a power supply control unit 14, and a real-time clock 15.

Further, the management apparatus 10 includes, in addition to the above-described configuration, a first instrument network communication interface 16a (a first communication unit), a second instrument network communication interface 16b (a second communication unit), and a third instrument network communication interface 16c (a third communication unit).

The microcomputer 11 is a microcomputer having a central processing unit (CPU). The ROM 12 is a memory area for storing predetermined data in addition to an operating system (OS) and various programs. The RAM 13 is a work memory area for causing the CPU of the microcomputer 11 to execute a program. The power supply control unit 14 performs predetermined power conversion to output the converted power to the microcomputer 11. The real-time clock 15 has the function of acquiring the time.

The first instrument network communication interface 16a transmits data to or receives data from the air-conditioner 20 (see FIG. 1) via the first instrument network ka based on the predetermined protocol. The first instrument network communication interface 16a is connected to the air-conditioner 20 via the first instrument network ka.

The second instrument network communication interface 16b transmits/receives data via the second instrument network kb based on each communication protocol of the monitoring camera 30 (see FIG. 1), the door lock mechanism 41, and the illuminating apparatus 50. The second instrument network communication interface 16b is connected to an instrument such as the monitoring camera 30 via the second instrument network kb.

The third instrument network communication interface 16c is a communication interface connectable to an upper apparatus (not shown) such as a building management system controller (a BMS controller: not shown). In the first embodiment, a case where no upper apparatus is connected to the third instrument network communication interface 16c will be described as one example.

FIG. 2B is a diagram for describing the functional configuration of the management apparatus 10.

As shown in FIG. 2B, the management apparatus 10 includes, as the functional configuration, an instrument management database 17, a first communication unit 18a, a second communication unit 18b, a third communication unit 18c, and a control unit 19.

The instrument management database 17 is a database linking, in a predetermined manner, not only data for specifying the instruments targeted for management, such as the air-conditioner 20 (see FIG. 1) and the monitoring camera 30, but also data indicating the above-described instrument states. Moreover, the instrument management database 17 also includes data on a predetermined cooperation rule used for the above-described cooperation control. Note that a specific example of the cooperation rule will be described later.

The first communication unit 18a performs predetermined communication via the first instrument network communication interface 16a (see FIG. 2A). The second communication unit 18b performs predetermined communication via the second instrument network communication interface 16b (see FIG. 2A). The third communication unit 18c performs predetermined communication via the third instrument network communication interface 16c (see FIG. 2A).

The control unit 19 executes predetermined processing for performing the cooperation control for each instrument. As shown in FIG. 2B, the control unit 19 includes a database building unit 191, a service execution unit 192, and an information processing unit 193.

The database building unit 191 has the function of building the instrument management database 17 based on data acquired from an instrument such as the air-conditioner 20 (see FIG. 1) or the monitoring camera 30.

The service execution unit 192 generates a control command for a predetermined instrument based on the predetermined cooperation rule included in the instrument management database 17 and a combination of the instrument states.

The information processing unit 193 analyzes data received from each instrument via the first communication unit 18a or the second communication unit 18b, thereby converting the data into a predetermined format suitable for the instrument management database 17. Moreover, the information processing unit 193 converts the control command input from the service execution unit 192 into data according to a predetermined communication protocol corresponding to an instrument as a transmission destination. Then, the information processing unit 193 outputs the converted data to the first communication unit 18a, the second communication unit 18b, or the third communication unit 18c.

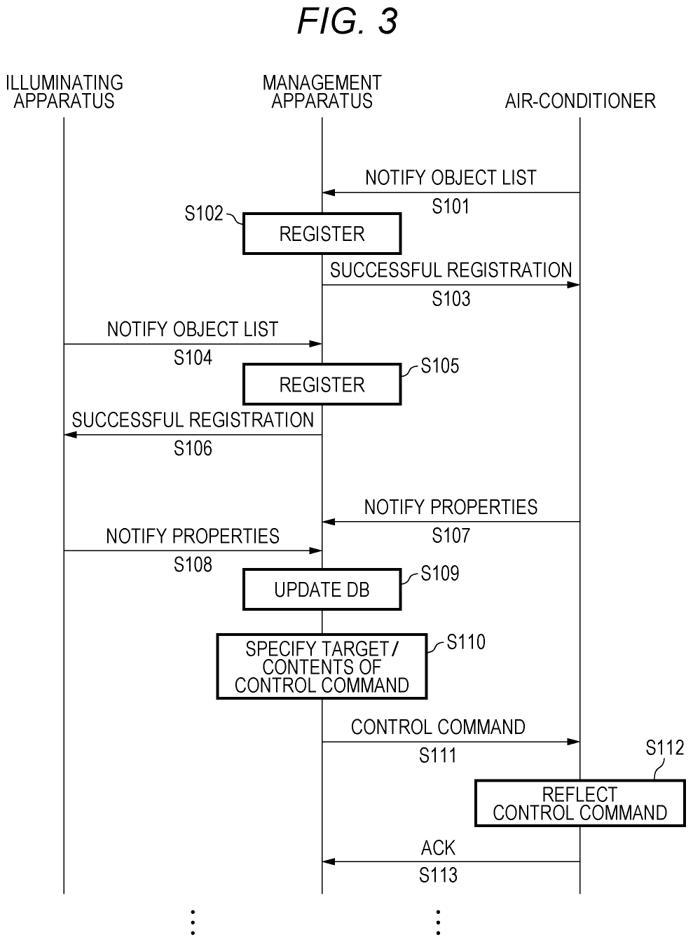

FIG. 3 is a sequence diagram of processing in the management system (also see FIG. 1, as necessary).

Note that FIG. 3 shows the air-conditioner 20 and the illuminating apparatus 50 among the targets for management by the management apparatus 10, but the same also applies to the remaining targets such as the monitoring camera 30 and the door lock mechanism 41 (see FIG. 1).

It is assumed that right before the start of the processing at a step S101, the air-conditioner 20 is connected to the management apparatus 10 via the first instrument network ka and the illuminating apparatus 50 is connected to the management apparatus 10 via the second instrument network kb.

The steps S101 to S106 of FIG. 3 are the processing of registering information on the air-conditioner 20 and the illuminating apparatus 50 in the instrument management database 17 (see FIG. 2B) of the management apparatus 10.

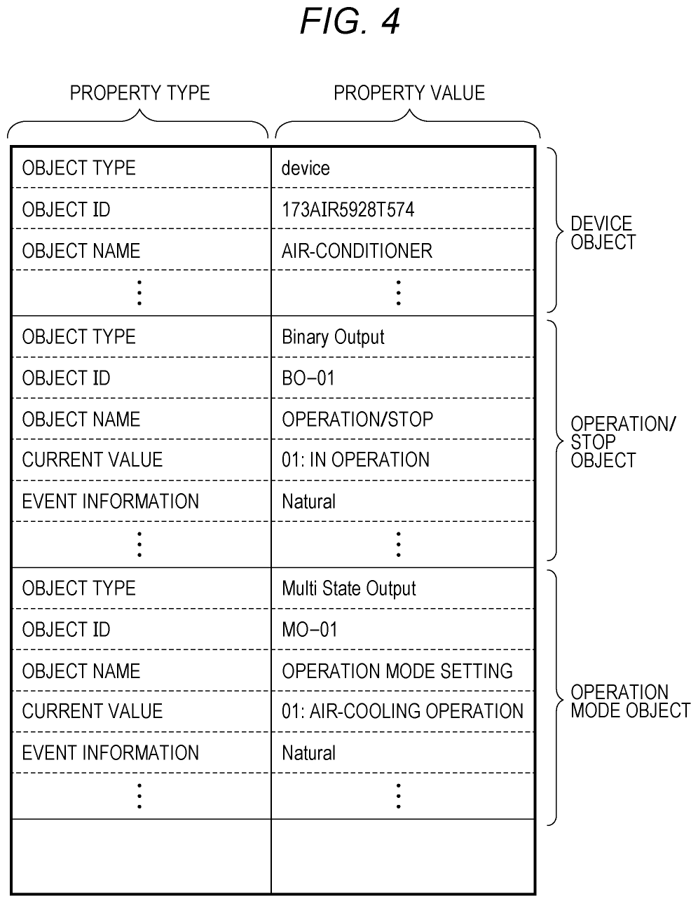

First, at the step S101, the air-conditioner 20 notifies the management apparatus 10 of a predetermined object list via the first instrument network ka. The object list described herein is a list that the information on the air-conditioner 20 is indicated by the group of predetermined objects (see FIG. 4). Note that the details of the object list will be described later.

At the step S102, the management apparatus 10 registers the object list. That is, the management apparatus 10 registers, as one target for the cooperation control, the object list for the air-conditioner 20 in the instrument management database 17 (see FIG. 2B).

At the step S103, the management apparatus 10 transmits a signal, which indicates successful registration of the object list, to the air-conditioner 20 via the first instrument network ka.

Similarly, in a case where the illuminating apparatus 50 is connected via the second instrument network kb, the management apparatus 10 also registers an object list for the illuminating apparatus 50 in the instrument management database 17, and further transmits a signal, which indicates successful registration, to the illuminating apparatus 50 (S104 to S106).

Steps S107 to S113 of FIG. 3 are the processing relating to the cooperation control between the air-conditioner 20 and the illuminating apparatus 50.

At the step S107, the air-conditioner 20 notifies the management apparatus 10 of its own properties via the first instrument network ka. For example, the air-conditioner 20 notifies, as its own properties, the management apparatus 10 of information including not only an operation/stop state at this point but also an operation mode, a set temperature, an indoor temperature detection value, and the presence or absence of an abnormality.

At the step S108, the illuminating apparatus 50 notifies the management apparatus 10 of its own properties via the second instrument network kb. That is, the illuminating apparatus 50 notifies the management apparatus 10 of an ON/OFF state at this point.

At the step S109, the management apparatus 10 updates the instrument management database 17. That is, the management apparatus 10 writes the latest property values of the air-conditioner 20 and the illuminating apparatus 50 in a predetermined storage area, thereby updating the instrument management database 17.

At the step S110, the management apparatus 10 specifies the target/contents of the control command. That is, the management apparatus 10 specifies the target (e.g., the air-conditioner 20) and contents (e.g., stop of the air-conditioning operation) of the control command with reference to the predetermined cooperation rule in the instrument management database 17 and the latest properties of the air-conditioner 20 and the illuminating apparatus 50. Note that the specific example of the cooperation rule will be described later.

At the step S111, the management apparatus 10 transmits a predetermined control command to the air-conditioner 20 specified at the step S110 via the first instrument network ka.

At the step S112, the air-conditioner 20 reflects the control command received from the management apparatus 10. For example, the air-conditioner 20 stops the air-conditioning operation, which is performed so far, based on the command from the management apparatus 10. Note that confirmation buttons (not shown) for confirming whether or not such control is to be performed may be displayed on the remote controllers 24, 25 and the air-conditioner 20 may perform such control in a case where the confirmation buttons is pressed by user's operation.

At the step S113, the air-conditioner 20 transmits, as a response to the control command at the step S111, an ACK signal to the management apparatus 10 via the first instrument network ka. Note that the processing of the steps S107 to S113 is repeated in a predetermined manner.

Regarding the processing of the steps S111 to S113, depending on the timing of the processing or each instrument state, a control command may be transmitted from the management apparatus 10 to the illuminating apparatus 50 or no control command may be transmitted to the air-conditioner 20 or the illuminating apparatus 50.

FIG. 4 is a view for describing an example of the object list regarding the air-conditioner 20.

The object list of FIG. 4 is the list that the information regarding the air-conditioner 20 is indicated by the group of predetermined objects, and is notified to the management apparatus 10 from the air-conditioner 20 via the first instrument network ka (see FIG. 1) (S101 of FIG. 3).

As shown in FIG. 4, one object (e.g., a device object) includes multiple pieces of data with pairs of a property type and a property value. For example, the device object of the air-conditioner 20 includes, as the property type, not only an object type and an object ID but also an object name, and predetermined property values are each set corresponding to the property types. Note that each property value of the device object is normally a fixed value.

An operation/stop object of the air-conditioner 20 includes, as the property type, not only an object type and an object ID but also an object name, a current value, and event information. Among these property types, property values of the object type, the object ID, and the object name are fixed values, and on the other hand, property values of the current value and the event information vary from hour to hour according to the state of the air-conditioner 20.

In a case where the air-conditioner 20 is connected to the management apparatus 10 via the first instrument network ka, the object list of FIG. 4 is notified to the management apparatus 10 from the air-conditioner 20 (S101 of FIG. 3), and is registered in the instrument management database 17 (see FIG. 2B) of the management apparatus 10 (S102).

After the object list is registered, the latest object list including the “CURRENT VALUE” in FIG. 4 is also transmitted from the air-conditioner 20 to the management apparatus 10 (S107 of FIG. 3), and the instrument management database 17 (see FIG. 2B) of the management apparatus 10 is updated accordingly (S109). That is, the “PROPERTIES” described at the step S107 of FIG. 3 mean the latest object list after each instrument is registered in the management apparatus 10. The instrument management database 17 is updated as described above, and in this manner, the latest state of each instrument including the air-conditioner 20 is grasped on a management apparatus 10 side.

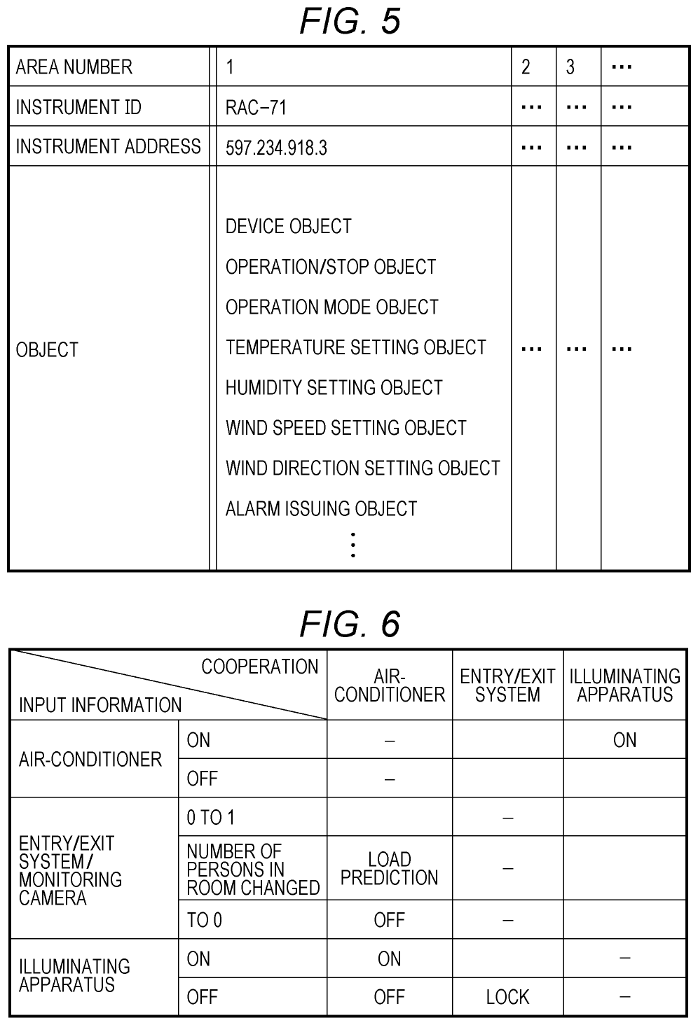

FIG. 5 is a diagram for describing an example of the instrument management database 17 included in the management apparatus 10.

In the example of FIG. 5, a predetermined area (e.g., an area number: 1) is provided as a storage area for storing multiple objects regarding one instrument (e.g., the air-conditioner 20). Moreover, predetermined instrument IDs are set to the instruments in one-to-one correspondence. For example, an instrument ID of “RAC-71” is set to the air-conditioner 20. Further, a predetermined instrument address is set to each area for linking instrument information and the storage area to each other.

When a new instrument is registered in the instrument management database 17, the database building unit 191 (see FIG. 2B) searches a free area in a predetermined storage area to set an instrument address, associates the instrument address with a predetermined instrument ID, and stores an object list notified from the instrument.

The instrument management database 17 stores not only the multiple objects shown in FIG. 5, but also data regarding the cooperation rule for the instruments. The “cooperation rule” is a rule defining the control contents of the above-described cooperation control. Such a cooperation rule will be described with reference to FIG. 6.

FIG. 6 is a diagram for describing an example of the cooperation rule set in the management apparatus 10 (also see FIG. 1, as necessary).

Note that “INPUT INFORMATION” in FIG. 6 is information included in predetermined properties (e.g., S107, S108 of FIG. 3) repeatedly notified (input) from each instrument to the management apparatus 10. On the other hand, “COOPERATION” in FIG. 6 is control contents for a predetermined instrument (a control command output destination) specified based on the input information.

In the example of FIG. 6, in a case where the air-conditioner 20 is turned “ON” by operation of the remote controller 24, 25 (see FIG. 1) by a user, the management apparatus 10 is set to switch the illuminating apparatus 50 to “ON.”

Based on the information from the monitoring camera 30 and the card readers 42, in a case where a person entered a room which has been an empty room so far (“0 TO 1”), the management apparatus 10 switches the air-conditioner 20 to “ON.” Then, the management apparatus 10 predicts an air-conditioning load according to the number of persons in the room, and reflects such prediction on air-conditioning control as necessary. Thereafter, in a case where the room becomes empty (“TO 0”), the management apparatus 10 switches the air-conditioner 20 to “OFF.”

In a case where at least one of multiple illuminating apparatuses 50 is turned “ON” by operation of a switch (not shown) by the user, the management apparatus 10 also switches the air-conditioner 20 to “ON.” Note that refrigerant may flow in an indoor unit in the vicinity of an area where the illuminating apparatus 50 is “ON” and no refrigerant may flow in the remaining indoor units.

In a case where all of the illuminating apparatuses 50 in the room are turned “OFF” by operation of the switches (not shown) by the user, the management apparatus 10 also switches the air-conditioner 20 to “OFF,” and switches the door lock mechanism 41 of the entry/exit system 40 to a “LOCK” state.

Then, the control unit 19 controls the air-conditioner 20 or other instruments based on a combination of the state of the air-conditioner 20 received via the first instrument network communication interface 16a (see FIG. 2A) and the states of the other instruments received via the second instrument network communication interface 16b (see FIG. 2A). The cooperation control for the multiple types of instruments is performed as described above, so that management of an office etc. can be easily properly performed.

Note that blanks in the table of FIG. 6 are set as necessary based not only on each instrument state but also on other types of information such as a day of the week and a time period. Such a cooperation rule is, in association with the instrument ID of each instrument, stored as part of the instrument management database 17 (see FIG. 2B) in the management apparatus 10.

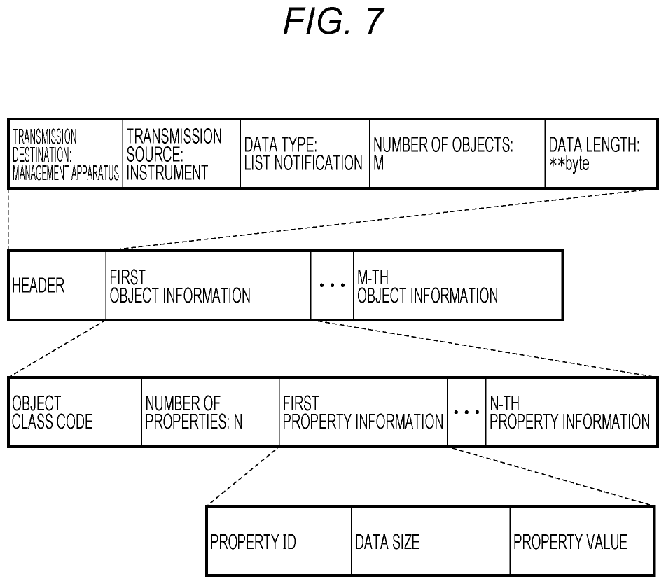

FIG. 7 shows an example of a packet format of information notified as the object list to the management apparatus 10.

As shown in the second line from the top of FIG. 7, the head of a packet notified as the object list to the management apparatus 10 (S101, S104 of FIG. 3) is a predetermined header, followed by M pieces of object information. The above-described header includes an object list transmission destination (the management apparatus 10), an object list transmission source (a predetermined instrument), a data type (a list notification), the number of objects (M), and a data length (**byte).

Each piece of object information includes not only a predetermined object class code and the number of properties (N), but also property information on each property. Each piece of property information includes not only a predetermined property ID, but also a data size and a property value. As described above, there are, as the property value, a fixed value and a value varying according to the instrument state. Note that the packet format of the properties (S107, S108 of FIG. 3) notified to the management apparatus 10 from an instrument is similar to that of FIG. 7.

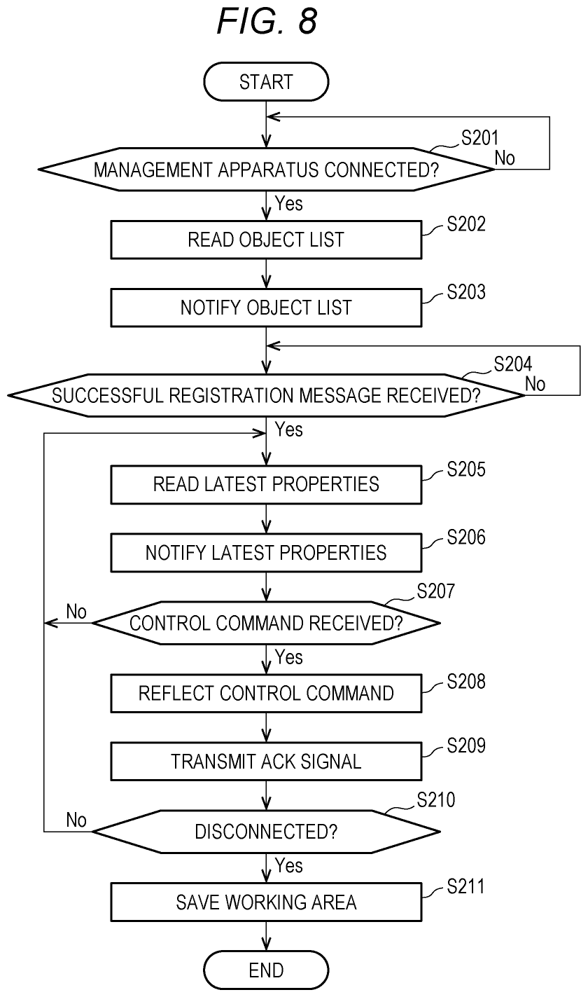

FIG. 8 is a flowchart showing the processing of the air-conditioner 20 (see FIGS. 1 and 3, as necessary).

At a step S201 of FIG. 8, the air-conditioner 20 determines whether or not the air-conditioner 20 is connected to the management apparatus 10 via the first instrument network ka. In a case where the air-conditioner 20 is not connected to the management apparatus 10 (S201: No), the air-conditioner 20 repeats the processing of the step S201. On the other hand, in a case where the air-conditioner 20 is connected to the management apparatus 10 (S201: Yes), the processing of the air-conditioner 20 proceeds to a step S202.

At the step S202, the air-conditioner 20 reads the object list from a storage unit (not shown) of the air-conditioner 20 itself.

At a step S203, the air-conditioner 20 notifies the management apparatus 10 of the object list via the first instrument network ka.

At a step S204, the air-conditioner 20 determines whether or not the air-conditioner 20 received a successful registration message from the management apparatus 10 via the first instrument network ka. In a case where the air-conditioner 20 does not receive the successful registration message from the management apparatus 10 (S204: No), the air-conditioner 20 repeats the processing of the step S204. On the other hand, in a case where the air-conditioner 20 received the successful registration message from the management apparatus 10 (S204: Yes), the processing of the air-conditioner 20 proceeds to a step S205.

At the step S205, the air-conditioner 20 reads the latest properties from the storage unit (not shown) of the air-conditioner 20 itself.

At a step S206, the air-conditioner 20 notifies the management apparatus 10 of the latest properties via the first instrument network ka.

At a step S207, the air-conditioner 20 determines whether or not the air-conditioner 20 received a predetermined control command from the management apparatus 10. In a case where the air-conditioner 20 does not receive the control command from the management apparatus 10 (S207: No), the processing of the air-conditioner 20 returns to the step S205. On the other hand, in a case where the air-conditioner 20 received the control command from the management apparatus 10 (S207: Yes), the processing of the air-conditioner 20 proceeds to a step S208.

At the step S208, the air-conditioner 20 reflects the control command from the management apparatus 10 on the air-conditioning control.

At a step S209, the air-conditioner 20 transmits an ACK signal for the control command to the management apparatus 10 via the first instrument network ka.

At a step S210, the air-conditioner 20 determines whether or not the air-conditioner 20 is disconnected from the management apparatus 10. In a case where the air-conditioner 20 is not disconnected from the management apparatus 10 (S210: No), the processing of the air-conditioner 20 returns to the step S205. On the other hand, in a case where the air-conditioner 20 is disconnected from the management apparatus 10 by, e.g., power-off (S210: Yes), the processing of the air-conditioner 20 proceeds to a step S211.

At the step S211, the air-conditioner 20 saves a working area of the storage unit (not shown), and ends a series of processing (END). Note that processing similar to that of FIG. 8 is also performed in an instrument other than the air-conditioner 20.

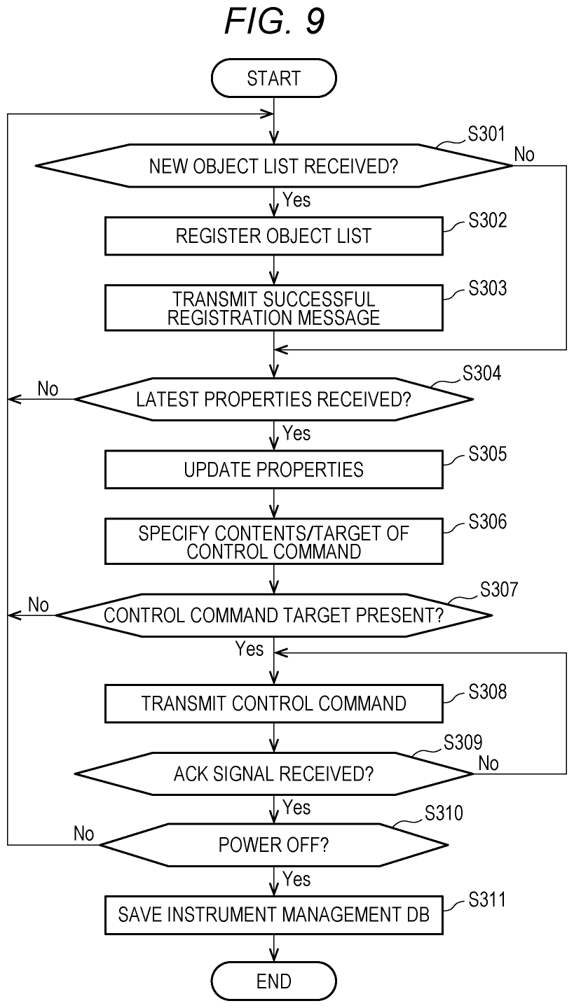

FIG. 9 is a flowchart showing the processing of the control unit 19 of the management apparatus 10 (see FIGS. 1 and 3, as necessary).

At a step S301, the control unit 19 determines whether or not the control unit 19 received a new object list from a predetermined instrument. In a case where the control unit 19 received the new object list from the instrument (S301: Yes), the processing of the control unit 19 proceeds to a step S302.

At the step S302, the control unit 19 registers the object list in the instrument management database 17.

At a step S303, the control unit 19 transmits a successful registration message to the instrument whose object list has been registered, and the processing proceeds to the processing of a step S304. In a case where no new object list is received from the instrument at the step S301 (S301: No), the processing of the control unit 19 also proceeds to the step S304.

At the step S304, the control unit 19 determines whether or not the control unit 19 received the latest properties from any instrument. In a case where the control unit 19 does not receive the latest properties (S304: No), the processing of the control unit 19 returns to the step S301. On the other hand, in a case where the control unit 19 received the latest properties (S304: Yes), the processing of the control unit 19 proceeds to a step S305.

At the step S305, the control unit 19 updates, for the instrument from which the latest properties are received, the properties in the instrument management database 17.

At a step S306, the control unit 19 specifies the contents/target of the control command. That is, the control unit 19 specifies the contents/target of the control command based on the predetermined cooperation rule (see FIG. 6) included in the instrument management database 17 and the properties of each instrument at this point.

At a step S307, the control unit 19 determines whether or not there is an instrument targeted for the control command. In a case where there is the instrument targeted for the control command (S307: Yes), the processing of the control unit 19 proceeds to a step S308. On the other hand, when there is no instrument targeted for the control command (S307: No), the processing of the control unit 19 returns to the step S301.

At the step S308, the control unit 19 transmits a predetermined control command to the instrument specified at the step S306. Accordingly, the control based on the cooperation rule is reflected on the predetermined instrument.

At a step S309, the control unit 19 determines whether or not the control unit 19 received an ACK signal from the instrument to which the control command is transmitted at the step S308. In a case where the control unit 19 received the ACK signal from the instrument (S309: Yes), the processing of the control unit 19 proceeds to a step S310. On the other hand, the control unit 19 does not receive the ACK signal from the instrument (S309: No), the processing of the control unit 19 returns to the step S308.

At the step S310, the control unit 19 determines whether or not a power supply of the control unit 19 itself is turned off by, e.g., manager's operation. In a case where the power supply is turned off (S310: Yes), the processing of the control unit 19 proceeds to a step S311. On the other hand, in a case where the power supply is not turned off (S310: No), the processing of the control unit 19 returns to the step S301.

At the step S311, the control unit 19 saves the instrument management database 17 (see FIG. 2B), and ends a series of processing (END).

Note that although not shown in FIG. 9, in a case where the upper apparatus (e.g., the BMS controller: not shown) is connected to the management apparatus 10, the control unit 19 of the management apparatus 10 executes predetermined control such that a command from the BMS controller is directly reflected on each instrument, for example.

### Advantageous Effects

According to the first embodiment, the management apparatus 10 having a relatively-simple configuration performs the cooperation control for the multiple types of instruments based on the predetermined cooperation rule. Moreover, it is configured such that in a case where there is no upper apparatus (not shown) such as the BMS controller, the management apparatus 10 also independently performs the cooperation control for each instrument. Thus, there is no need to provide an expensive apparatus such as the BMS controller (not shown), and therefore, the multiple types of instruments can be managed at low cost. Further, the management apparatus 10 can be used regardless of the presence or absence of the BMS controller, and therefore, there is an advantage that general versatility is high.

Flexible action can be taken on a manager side while a cost is reduced according to the size of a building. For example, the management apparatus 10 is used for a small-sized building while both of the BMS controller and the management apparatus 10 are used for a large-sized building.

### Second Embodiment

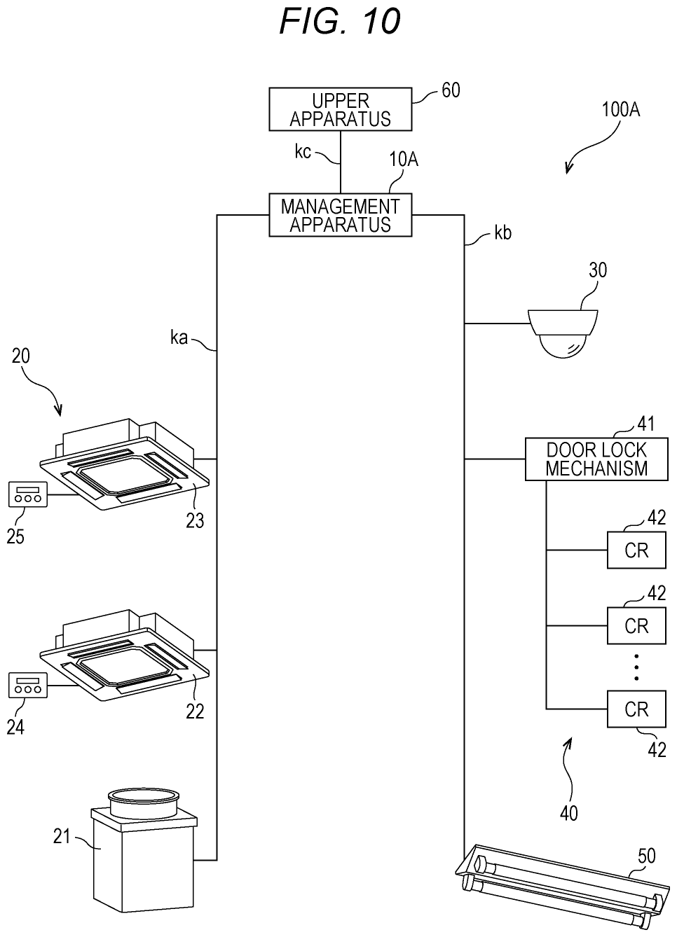

A management system 100A (see FIG. 10) according to a second embodiment is different from that of the first embodiment in that an upper apparatus 60 is connected to a management apparatus 10A. Moreover, the second embodiment is different from the first embodiment in that a subject managing each instrument is switched according to a time period. Note that other points (e.g., the configuration of the management apparatus 10A) are similar to those of the first embodiment. Thus, the differences from the first embodiment will be described, and description of overlapping contents will be omitted.

FIG. 10 is a configuration diagram of the management system 100A including the management apparatus 10A according to the second embodiment.

As shown in FIG. 10, the management system 100A includes the management apparatus 10A and the upper apparatus 60, and also includes a first instrument network ka, a second instrument network kb, and a third instrument network kc.

The upper apparatus 60 is an apparatus configured to manage each instrument sequentially via the third instrument network kc and the management apparatus 10A. As the upper apparatus 60, a building management system controller (a BMS controller) configured to perform predetermined communication based on a building automation and control networking protocol (BACnet) can be used, for example. The third instrument network kc is a communication line connecting a third instrument network communication interface 16c (see FIG. 2A) of the management apparatus 10A and the upper apparatus 60 to each other.

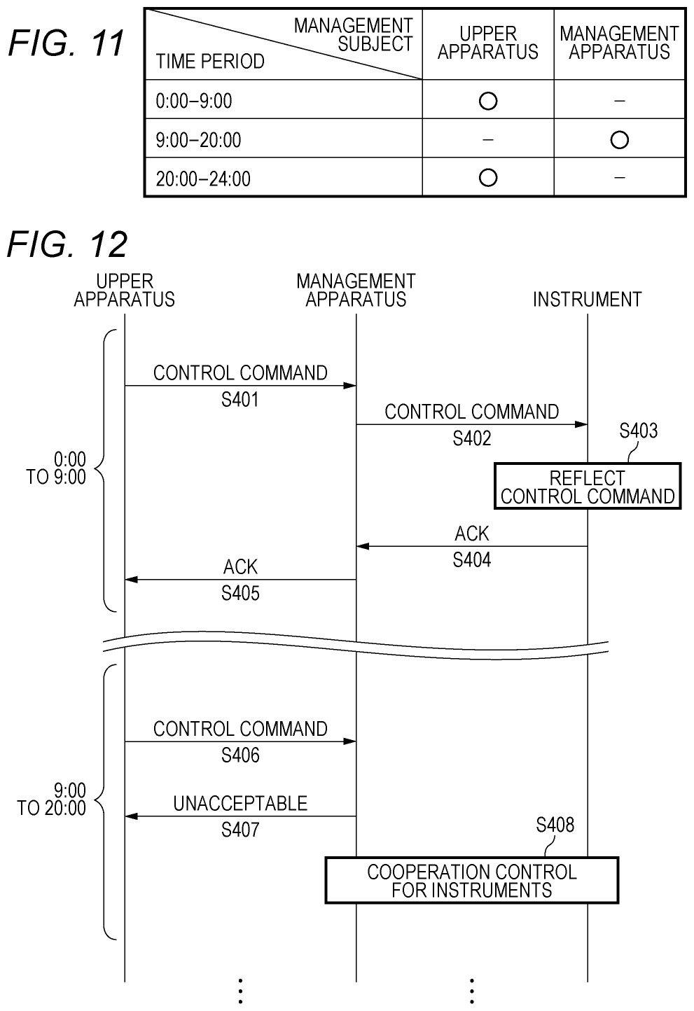

Note that the configuration of the management apparatus 10A is similar to that described in the first embodiment (FIGS. 2A and 2B), but is different from that of the first embodiment in that data regarding switching of the instrument management subject (see FIG. 11) is included in an instrument management database.

FIG. 11 is a diagram for describing switching of the management subject (also see FIG. 10, as necessary).

In an example of FIG. 11, the management subject for each instrument is the upper apparatus 60 in a time period of 0:00 to 9:00 and a time period of 20:00 to 24:00. On the other hand, in a time period of 9:00 to 20:00, the management subject for each instrument is the management apparatus 10A. That is, the management subject for each instrument is switched from the upper apparatus 60 to the management apparatus 10A at 9:00, and is switched from the management apparatus 10A to the upper apparatus 60 at 20:00. Setting information regarding such switching of the management subject is, together with a cooperation rule (see FIG. 6) for each instrument, also stored in advance in the instrument management database 17 (see FIG. 2B).

Note that the above-described BMS controller may be used as the upper apparatus 60, and on the other hand, a tenant management system controller (a TMS controller) may be used as the management apparatus 10A. The TMS controller has such characteristics that the TMS controller is less expensive than the BMS controller and a fine setting change can be easily performed for the TMS controller.

FIG. 12 is a time chart regarding the upper apparatus 60, the management apparatus 10A, and an instrument.

Note that a time chart in a time period of 0:00 to 9:00 is shown on the upper side on the plane of paper of FIG. 12 and a time chart in a time period of 9:00 to 20:00 is shown on the lower side on the plane of paper of FIG. 12.

As described above, the management subject for the instrument such as an air-conditioner 20 is the upper apparatus 60 in a time period of 0:00 to 9:00 (see FIG. 11).

At a step S401, the upper apparatus 60 transmits a control command targeted for the predetermined instrument to the management apparatus 10A. Note that it is assumed that a predetermined condition as a trigger for the processing of the step S401 is satisfied.

At a step S402, the management apparatus 10A transmits the control command received from the upper apparatus 60 to the target instrument. That is, the management apparatus 10A transmits, with reference to an instrument ID (see FIG. 5) included in the control command, the control command from the upper apparatus 60 to the predetermined instrument having an instrument address (see FIG. 5) as an address.

At a step S403, the instrument having received the control command reflects the control command, and executes predetermined control.

At a step S404, the instrument having reflected the control command transmits an ACK signal for the control command to the management apparatus 10A.

At a step S405, the management apparatus 10A transmits the ACK signal, which is received by the management apparatus 10A itself, for the control command (S401) to the upper apparatus 60. As described above, the management apparatus 10A mediates information exchange between the upper apparatus 60 and the instrument in a time period of 0:00 to 9:00 (see FIG. 11). In a case where the upper apparatus 60 is the management subject as described above, a control unit 19 of the management apparatus 10A reflects the control command from the upper apparatus 60 on the control for the air-conditioner 20 or other instruments.

Note that although not shown in FIG. 12, the processing of transmitting data, which includes the latest properties of the instrument, to the upper apparatus 60 via the management apparatus 10A is repeated as necessary. That is, in a case where the upper apparatus 60 is the management subject, the control unit 19 of the management apparatus 10A repeats the processing of transmitting a signal, which indicates the states of the air-conditioner 20 and the other instruments, to the upper apparatus 60. At this point, the management apparatus 10A may update the instrument management database 17 based on the latest properties of the instrument. With this configuration, the management apparatus 10A can execute cooperation control for each instrument by means of the latest properties included in the instrument management database 17 immediately after the management subject for the instrument is switched from the upper apparatus 60 to the management apparatus 10A at 9:00.

After the processing of the steps S401 to S405 is repeated, the management subject is switched at 9:00, and the processing of steps S406 to S408 is performed in a time period of 9:00 to 20:00.

At the step S406, the upper apparatus 60 transmits a control command targeted for the predetermined instrument to the management apparatus 10A. Note that it is assumed that a predetermined condition as a trigger for the processing of the step S406 is satisfied.

At the step S407, the management apparatus 10A replies a signal (an unacceptable signal), which indicates a time period in which the control command cannot be accepted, to the upper apparatus 60 as a response to the control command from the upper apparatus 60. That is, in a case where the management apparatus 10A itself is the management subject, when the control command is received from the upper apparatus 60 (S406), the control unit 19 of the management apparatus 10A replies a signal, which indicates that the control command is not transmitted to the air-conditioner 20 or the other instruments, to the upper apparatus 60 (S407).

At the step S408, the management apparatus 10A executes the cooperation control for the instruments. Note that the cooperation control for the instruments is similar to that of the first embodiment (S107 to S113 of FIG. 3), and therefore, description thereof will be omitted. Then, the processing of the steps S406 to 408 is repeated in a predetermined manner in a time period of 9:00 to 20:00.

As described above, in a case where the management apparatus 10A itself is the management subject, the control unit 19 of the management apparatus 10A controls the air-conditioner 20 or the other instruments based on a combination of instrument states regardless of the presence of absence of the control command from the upper apparatus 60 (i.e., the upper apparatus 60 is ignored, as it were). With this configuration, in a time period of 9:00 to 20:00, the management apparatus 10A can execute the cooperation control for each instrument based on the predetermined cooperation rule (see FIG. 6) without receiving influence from the upper apparatus 60.

In a case where the management apparatus 10A is the management subject for the instrument, the control unit 19 of the management apparatus 10A does not necessarily transmit the signal (the properties), which indicates the states of the air-conditioner 20 and the other instruments, to the upper apparatus 60. This is because the management apparatus 10A does not accept the control command from the upper apparatus 60 in a time period of 9:00 to 20:00, and therefore, there is little need to transmit the properties of each instrument to the upper apparatus 60.

Although not shown in FIG. 12, the management subject for the instrument is switched from the management apparatus 10A to the upper apparatus 60 at 20:00 (see FIG. 11). When the management subject for the instrument is switched from the management apparatus 10A to the upper apparatus 60 as described above, the management apparatus 10A may transmit a signal (the properties), which indicates the latest states of the air-conditioner 20 and the other instruments, to the upper apparatus 60. Accordingly, the upper apparatus 60 can transmit a predetermined control command to the instrument immediately after the upper apparatus 60 itself is switched to the management subject for the instrument.

The information (see FIG. 11) regarding such switching of the management subject for the instrument is, together with an object list and the predetermined cooperation rule, included in the instrument management database 17 (see FIG. 2B) of the management apparatus 10A.

The management apparatus 10A may be configured not to notify the upper apparatus 60 of information on the predetermined cooperation rule (see FIG. 6) regarding the cooperation control for the instrument. With this configuration, in a case where the management apparatus 10A is additionally provided, there is no need to perform a complicated setting change in the upper apparatus 60, and therefore, a burden on a manager can be reduced.

Note that a time chart in a time period of 20:00 to 24:00 (see FIG. 11) is similar to that of the steps S401 to S405 of FIG. 12, and therefore, description thereof will be omitted.

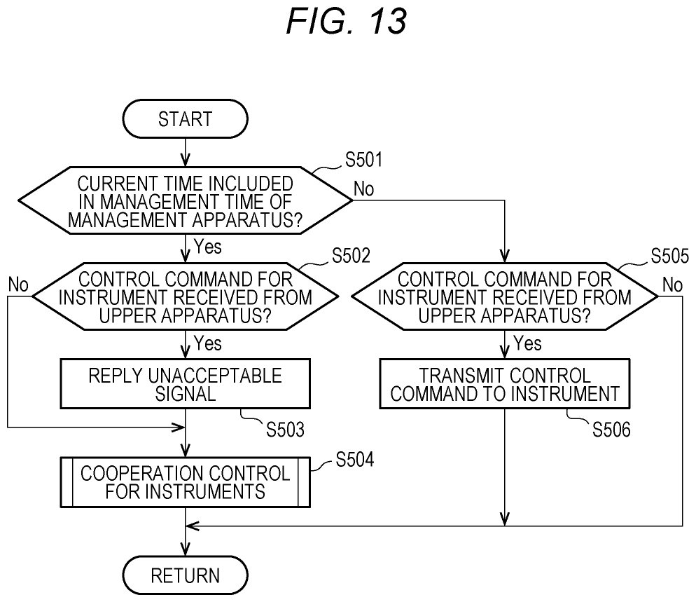

FIG. 13 is a flowchart showing the processing contents of the control unit 19 of the management apparatus 10A.

At a step S501, the control unit 19 determines whether or not the current time is included in a management time of the management apparatus 10A. Note that the “management time” is a time period in which instrument operation is mainly managed. In a case where the current time is included in the management time of the management apparatus 10A (S501: Yes), the processing of the control unit 19 proceeds to a step S502. For example, in a case where the current time is 10:00, the current time is included in a management time of 9:00 to 20:00 (see FIG. 11), and therefore, the processing of the control unit 19 proceeds to the step S502.

At the step S502, the control unit 19 determines whether or not the control unit 19 received the control command for the instrument from the upper apparatus 60. In a case where the control unit 19 received the control command for the instrument from the upper apparatus 60 (S502: Yes), the processing of the control unit 19 proceeds to a step S503.

At the step S503, the control unit 19 transmits a signal (an unacceptable signal), which indicates that the control command cannot be accepted, to the upper apparatus 60 as a response to the control command from the upper apparatus 60, and the processing proceeds to the processing of a step S504. At the step S502, in a case where the control unit 19 does not receive the control command for the instrument from the upper apparatus 60 (S502: No), the processing of the control unit 19 also proceeds to the step S504.

At the step S504, the control unit 19 executes the cooperation control for the instruments. Note that the cooperation control is similar to that of the first embodiment (S107 to S113 of FIG. 3), and therefore, description thereof will be omitted. After the cooperation control for the instruments is performed at the step S504, the processing of the control unit 19 returns to “START” (“RETURN”).

On the other hand, in a case where the current time is not included in the management time of the management apparatus 10A at the step S501 (S501: No), the processing of the control unit 19 proceeds to a step S505. For example, in a case where the current time is 8:00, the current time is not included in a management time (see FIG. 11) of 9:00 to 20:00 in the management apparatus 10A, and on the other hand, is included in a management time of the upper apparatus 60. Thus, the processing of the control unit 19 proceeds to the step S505.

At the step S505, the control unit 19 determines whether or not the control unit 19 received the control command for the instrument from the upper apparatus 60. In a case where the control unit 19 received the control command for the instrument from the upper apparatus 60 (S505: Yes), the processing of the control unit 19 proceeds to a step S506.

At the step S506, the control unit 19 transmits the control command received from the upper apparatus 60 to the predetermined instrument. After the processing of the step S506 is performed, the processing of the control unit 19 returns to “START” (“RETURN”).

In a case where the control unit 19 does not receive the control command for the instrument from the upper apparatus 60 at the step S505 (S505: No), the processing of the control unit 19 also returns to “START” (“RETURN”).

### Advantageous Effects

According to the second embodiment, the management apparatus 10A mediates, in a predetermined time period (e.g., 0:00 to 9:00), the control command from the upper apparatus 60 to the instrument (S401 to S405 of FIG. 12). In another time period (e.g., 9:00 to 20:00), the management apparatus 10A executes the cooperation control for the instruments based on the predetermined cooperation rule (see FIG. 6) regardless of the presence or absence of the control command from the upper apparatus 60 (S406 to S408 of FIG. 12). With this configuration, the management apparatus 10A can serve as the subject to execute the cooperation control among the instruments in the predetermined time period.

The management apparatus 10A is, in some cases, additionally provided at an existing configuration (not shown) in which the upper apparatus 60 is directly connected to an instrument. In this case, the management subject for the instrument can be also switched between the upper apparatus 60 and the management apparatus 10A according to the time period with the setting of the upper apparatus 60 being little changed. Moreover, a user can easily change the cooperation rule (see FIG. 6) for the instrument. As described above, according to the second embodiment, a user's effort and a cost when the management subject is provided can be reduced.

### <Variations>

The management apparatuses 10, 10A etc. according to the present invention have been described above in each embodiment, but the present invention is not limited to such description and various changes can be made.

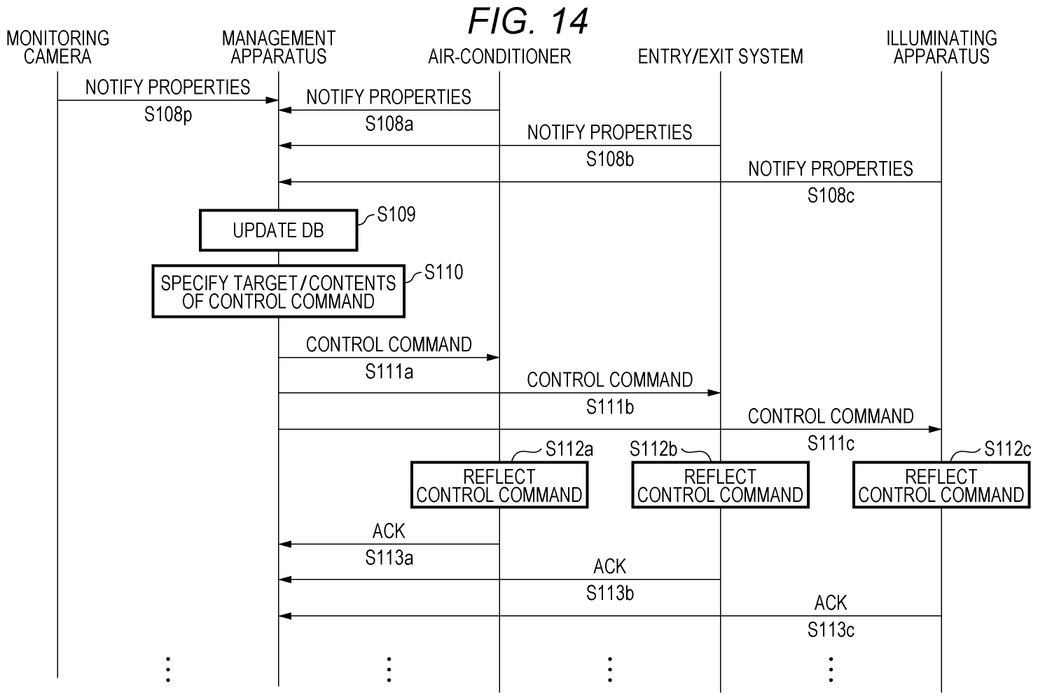

For example, with reference to FIG. 3 of the first embodiment, the processing (S111) has been described, in which the management apparatus 10 transmits the predetermined control command to the air-conditioner 20 based on the combination of the states of the illuminating apparatus 50 and the air-conditioner 20. However, the present invention is not limited to such processing. That is, as shown in FIG. 14, different control commands may be each transmitted to the multiple types of instruments from the management apparatus 10 based on the predetermined cooperation rule.

FIG. 14 is a sequence diagram of processing in a management system including a management apparatus 10 according to a variation (see FIG. 1, as necessary).

Note that in FIG. 14, the same step numbers are used to represent processing steps similar to those of FIG. 3.

As shown in FIG. 14, in a case where predetermined properties are transmitted to the management apparatus 10 from each of a monitoring camera 30, an air-conditioner 20, an entry/exit system 40, and an illuminating apparatus 50 (S108p, S108a to S108c), the management apparatus 10 updates an instrument management database (S109), and specifies the target/contents of a control command (S110). Then, in an example of FIG. 14, the management apparatus 10 transmits a predetermined control command to each of the air-conditioner 20, the entry/exit system 40, and the illuminating apparatus 50 (S111a to S111c). The timing of transmitting these control commands may be substantially the same among the instruments, or may be shifted among the instruments as necessary. Thereafter, each instrument reflects the control command (S112a to S112c), and replies an ACK signal to the management apparatus 10 (S113a to S113c). In such processing, in a case where locking by a door lock mechanism 41 (see FIG. 1) is, for example, not available because a predetermined apparatus is being driven, such a situation may be informed to a user via remote controllers 24, 25.

In the first embodiment, the case where the instrument control based on the predetermined cooperation rule is performed by the management apparatus 10 has been described, but the present invention is not limited to such a case. For example, a control unit 19 (see FIGS. 2A and 2B) may be built in the remote controller 24, 25 (see FIG. 1) of the air-conditioner 20, and the remote controller 24, 25 may control the instrument based on the predetermined cooperation rule. Alternatively, the instrument control based on the predetermined cooperation rule may be performed using a cloud computing system (not shown).

In the second embodiment, the case where the management subject for the instrument is switched based on the time period (see FIG. 11) has been described, but the present invention is not limited to such a case. For example, instead of the time period, a day of the week, the date, or a combination thereof may be used as necessary. That is, the management subject managing the air-conditioner 20 and the other instruments may be switched based on at least one of the time period, the day of the week, or the date.

In the second embodiment, the processing (S407) has been described, in which in a case where the management apparatus 10A is the management subject, when the management apparatus 10A receives the control command from the upper apparatus 60 (S406 of FIG. 12), the management apparatus 10 replies the unacceptable signal to the upper apparatus 60. However, the present invention is not limited to such processing. That is, in a case where the management apparatus 10A is the management subject, when the management apparatus 10A receives the control command from the upper apparatus 60, no reply may be provided from the management apparatus 10A to the upper apparatus 60 (the upper apparatus 60 may be ignored).

For example, in a case where the management apparatus 10A itself is the management subject, when the management apparatus 10A receives the control command from the upper apparatus 60, if such a control command is a predetermined control command (e.g., stop of operation of the air-conditioner 20) set in advance, the control unit 19 may transmit the control command to the air-conditioner 20 or the other instruments. If the control command is not the predetermined control command set in advance, the control unit 19 does not necessarily transmit the control command to the air-conditioner 20 or the other instruments. With this configuration, even in the time period in which the management apparatus 10A is the management subject, part of the control command from the upper apparatus 60 can be selectively reflected on, e.g., the air-conditioner 20.

In a case where the management apparatus 10A itself is the management subject, when the management apparatus 10A receives the control command from the upper apparatus 60, the control unit 19 may reply a signal, which indicates that the above-described control command is transmitted to the air-conditioner 20 or the other instruments, to the upper apparatus 60 although not actually transmitting the control command to the air-conditioner 20 or the other instruments. With this configuration, even when the upper apparatus 60 is, for example, set such that an error message is issued in a case where the control command is not reflected on the instrument, the management apparatus 10A can perform, as the management subject, the cooperation control for the instruments without the error message being issued.

In the second embodiment, the processing has been described, in which in a case where the management apparatus 10A is the management subject, the control unit 19 does not transmit the signal, which indicates the states of the air-conditioner 20 and the other instrument, to the upper apparatus 60. However, the present invention is not limited to such processing. That is, in a case where the upper apparatus 60 is the management subject, the control unit 19 may repeat the processing of transmitting the signal, which indicates the states of the air-conditioner 20 and the other instruments, to the upper apparatus 60. Even in a case where the management apparatus 10A itself is the management subject, the processing of transmitting the signal, which indicates the states of the air-conditioner 20 and the other instruments, to the upper apparatus 60 may be repeated. With this configuration, the upper apparatus 60 can transmit a predetermined control command regarding each instrument by way of the management apparatus 10A immediately after the management subject is switched to the upper apparatus 60.

In the second embodiment, the configuration has been described, in which the single management apparatus 10A (see FIG. 10) is provided. However, the present invention is not limited to such a configuration. For example, it may be configured such that multiple management apparatuses 10A are connected to the upper apparatus 60 in a tree shape and the air-conditioners 20 and the other instruments are each connected to the management apparatuses 10A in a tree shape.

In each embodiment, the configuration has been described, in which the second instrument network communication interface 16b (see FIG. 2A) of the management apparatus 10 is connected to three types of instruments (the monitoring camera 30, the door lock mechanism 41, and the illuminating apparatus 50: see FIG. 1) via the second instrument network kb. However, the present invention is not limited to such a configuration. For example, it may be configured such that the second instrument network communication interface 16b (see FIG. 2A) of the management apparatus 10 is connected to one or multiple types of instruments different from the air-conditioner 20 via the second instrument network kb.

In each embodiment, the example has been described, in which the monitoring camera 30 (see FIG. 1) is provided separately from the air-conditioner 20 (see FIG. 1). However, the present invention is not limited to such an example. That is, in a case where the air-conditioner 20 has the function of sensing a person in the room based on, an imaging result of, for example, a camera (not shown), the person sensing in the room result may be included in the properties, and such property information may be transmitted from the air-conditioner 20 to the management apparatus 10.

In each embodiment, the example has been described, in which the multi air-conditioner 20 configured such that the outdoor unit 21 (see FIG. 1) and the two indoor units 22, 23 (see FIG. 1) are connected to each other through the refrigerant pipe (not shown) is used. However, the present invention is not limited to such an example. That is, each embodiment is applicable to various types of air-conditioners.

The information including not only the predetermined programs described in each embodiment but also a database and a file can be stored in a recording apparatus such as a memory, a hard drive, or a solid state drive (SSD) or a recording medium such as an integrated circuit (IC) card, a SD card, or a digital versatile disc (DVD).

Each embodiment has described the details for the sake of simplicity in description of the present invention, and is not limited to one including all configurations described above. Moreover, for some of the configurations of each embodiment, addition/omission/replacement of other configurations can be made.

The above-described mechanisms and configurations are those assumed necessary for description, and do not include all mechanisms and configurations necessary for a product.

### LIST OF REFERENCE SIGNS

100 Management System
10, 10A Management Apparatus
20 Air-Conditioner
30 Monitoring Camera (Instrument)
41 Door Lock Mechanism (Instrument)
50 Illuminating Apparatus (Instrument)
16a First Instrument Network Communication Interface (First Communication Unit)
16b Second Instrument Network Communication Interface (Second Communication Unit)
16c Third Instrument Network Communication Interface (Third Communication Unit)
19 Control Unit
ka First Instrument Network
kb Second Instrument Network
kc Third Instrument Network
60 Upper Apparatus

1.-11. (canceled)

12. A management apparatus comprising:
a first communication unit connected to an air-conditioner via a first instrument network;
a second communication unit connected to one or more types of instruments different from the air-conditioner via a second instrument network;
a third communication unit connectable to an upper apparatus; and
a control unit configured to control the air-conditioner or the instruments based on a combination of a state of the air-conditioner received via the first communication unit and states of the instruments received via the second communication unit,
wherein the upper apparatus is connected to the third communication unit via a third instrument network,
a management subject managing the air-conditioner and the instruments is switched based on at least one of a time period, a day of a week, or a date,
in a case where the upper apparatus is the management subject, the control unit reflects a control command from the upper apparatus on control of the air-conditioner or the instruments, and
in a case where the management apparatus itself is the management subject, the control unit controls the air-conditioner or the instruments based on the combination regardless of a presence or absence of the control command from the upper apparatus.

13. The management apparatus according to claim 12, wherein
in a case where the management apparatus itself is the management subject, when the management apparatus receives the control command from the upper apparatus, the control unit replies a signal, which indicates that the control command is not transmitted to the air-conditioner or the instruments, to the upper apparatus.

14. The management apparatus according to claim 12, wherein
in a case where the management apparatus itself is the management subject, when the management apparatus receives the control command from the upper apparatus, the control unit transmits the control command to the air-conditioner or the instruments if the control command is a predetermined control command set in advance, and does not transmit the control command to the air-conditioner or the instruments if the control command is not the predetermined control command set in advance.

15. The management apparatus according to claim 12, wherein
in a case where the management apparatus itself is the management subject, when the management apparatus receives the control command from the upper apparatus, the control unit replies a signal, which indicates that the control command is transmitted to the air-conditioner or the instruments, to the upper apparatus although not actually transmitting the control command to the air-conditioner or the instruments.

16. The management apparatus according to claim 12, wherein
the management apparatus does not notify the upper apparatus of information on a predetermined cooperation rule defining a control content based on the combination.

17. The management apparatus according to claim 12, wherein
in a case where the upper apparatus is the management subject, the control unit repeats processing of transmitting a signal, which indicates the states of the air-conditioner and the instruments, to the upper apparatus, and in a case where the management apparatus itself is the management subject, the control unit does not transmit the signal, which indicates the states of the air-conditioner and the instruments, to the upper apparatus.

18. The management apparatus according to claim 17, wherein
when the management subject is switched from the management apparatus to the upper apparatus, the management apparatus transmits a signal, which indicates latest states of the air-conditioner and the instruments, to the upper apparatus.

19. The management apparatus according to claim 12, wherein
in a case where the upper apparatus is the management subject, the control unit repeats processing of transmitting a signal, which indicates the states of the air-conditioner and the instruments, to the upper apparatus, and
even in a case where the management apparatus itself is the management subject, the control unit repeats the processing of transmitting the signal, which indicates the states of the air-conditioner and the instruments, to the upper apparatus.

20. A management method executed by a management apparatus including a first communication unit connected to an air-conditioner via a first instrument network, a second communication unit connected to one or more types of instruments different from the air-conditioner via a second instrument network, a third communication unit connectable to an upper apparatus, and a control unit, wherein
the upper apparatus is connected to the third communication unit via a third instrument network,
the control unit controls the air-conditioner or the instruments based on a combination of a state of the air-conditioner received via the first communication unit and states of the instruments received via the second communication unit,
a management subject managing the air-conditioner and the instruments is switched based on at least one of a time period, a day of a week, or a date,
in a case where the upper apparatus is the management subject, the control unit reflects a control command from the upper apparatus on control of the air-conditioner or the instruments, and
in a case where the management apparatus itself is the management subject, the control unit controls the air-conditioner or the instruments based on the combination regardless of a presence or absence of the control command from the upper apparatus.

21. A program for causing a computer to execute the management method according to claim 20.
